(19) United States
(12) Patent Application Publication
(10) Pub. No.: US 2012/0275848 A1
(43) Pub. Date: Nov. 1, 2012

(54) CONNECTOR

(75) Inventors: GUO CHEN, Shenzhen City (CN); SHI-WEN ZHOU, Shenzhen City (CN); CHUN-CHI CHEN, Tu-Cheng (TW)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/197,767

(22) Filed: Aug. 3, 2011

(30) Foreign Application Priority Data
Apr. 26, 2011 (CN) 201110105235.3

(51) Int. Cl. F16B 19/04

(52) U.S. Cl. 403/280

(57) ABSTRACT

An exemplary connector includes a main body and a block engaged with the main body. The main body includes a central plate, a first extension plate extending downwardly from a lateral side of the central plate, and a second extension plate extending upwardly from an opposite lateral side of the central plate. Two riveting holes are defined through the central plate. The block includes a first securing plate and a second securing plate extending from the first securing plate and attached to the central plate of the main body. Two pins extend from the second securing plate and are punched to be engagingly received in the rivet holes of the central plate to engage with the main body.

### BACKGROUND

1. Technical Field

The present disclosure relates generally to connectors in electrical equipment, and more particularly to a connector using in an electronic device for mechanically connecting two or more pieces together.

2. Description of Related Art

Currently, many electronic devices have a small volume and are lightweight. Connectors used in these electronic devices are also miniaturized in order that they can conveniently fit inside the electronic devices.

A typical connector defines a plurality of apertures therein. The precision requirements of the positions of the apertures are so high that CNC (computer numerical control) machines are needed during manufacturing of the connector. However, CNC processing is complex and difficult, and the yield of the manufactured connectors is relatively low.

One method of reducing the above-described processing difficulties is to divide the connector into two parts. Each part has a more simple structure compared with the whole connector. The two parts are then engaged with each other by screws. However, the relative positions of the apertures in the two parts may not meet the necessary precision requirements when the screws are engaged in the two parts. In addition, the process of carrying out the screw engagement is troublesome.

What is needed, therefore, is an improved connector which can overcome the above-mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an isometric, exploded view of a connector in accordance with an embodiment of the present disclosure.

FIG. 2 is an assembled view of the connector of FIG. 1.

FIG. 3 is similar to FIG. 2, but showing the connector inverted.

FIG. 4 is a cross-sectional view of the connector of FIG. 3, taken along line IV-IV thereof.

### DETAILED DESCRIPTION

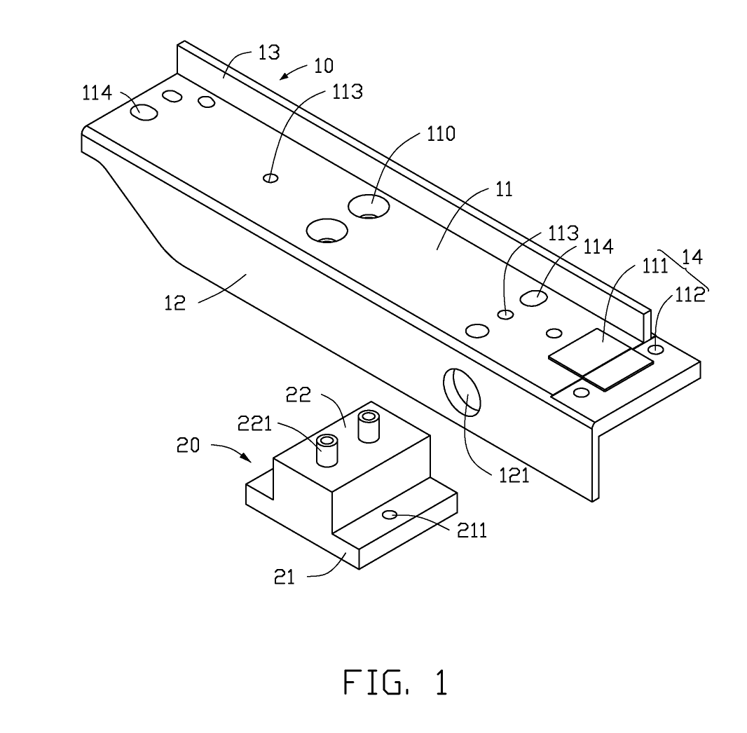

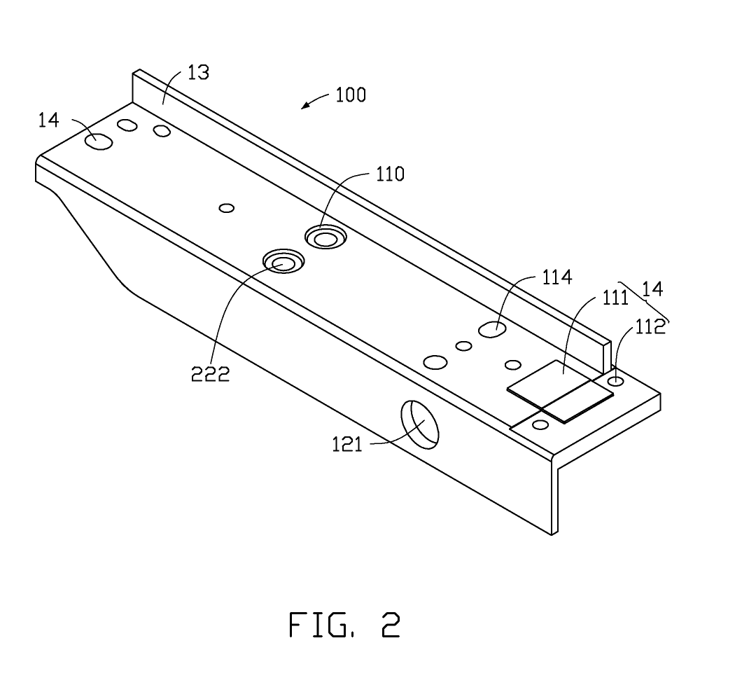

Referring to FIGS. 1 and 2, a connector 100 in accordance with an embodiment of the present disclosure comprises a main body 10 and a block 20 engaged with the main body 10. The connector 100 is used in electronic devices for connecting two or more pieces (objects) together.

The main body 10 comprises a central plate 11, a first extension plate 12 perpendicularly extending from a lateral side of the central plate 11, and a second extension plate 13 extending from an opposite lateral side of the central plate 11. The central plate 11 has a substantially rectangular shape. The first and second extension plates 12, 13 extend from two long lateral sides of the central plate 11. The first and second extension plates 12, 13 are perpendicular to the central plate 11, and extend from the central plate 11 in substantially opposite directions. In particular, the first extension plate 12 extends down from the central plate 11, and the second extension plate 13 extends up from the central plate 11.

Two riveting holes 110 are defined in a substantially central portion of the central plate 11. The riveting holes 110 are through holes that extend through bottom and top surfaces of the central plate 11. A line extending through centers of the riveting holes 110 is perpendicular to the long lateral sides of the central plate 11. Each riveting hole 110 has an isosceles trapezoidal cross section. The dimension (diameter) of the riveting hole 110 increases gradually along a direction from the bottom surface to the top surface of the central plate 11. A low-profile protrusion 111 is formed on the top surface of an end portion of the central plate 11. This end of the central plate 11 is stepped, and the protrusion 111 has a rectangular shape and is correspondingly stepped. Three auxiliary holes 112 are defined in the end of the central plate 11 and near three sides of the protrusion 111 respectively, for extension of screws (not shown). The protrusion 111 and the auxiliary holes 112 cooperate to form a reinforcing structure 14. The reinforcing structure 14 is used for engaging with other elements for increasing an intensity (strength) of the central plate 11. A plurality of assembly holes 113 are defined in the central plate 11. The assembly holes 113 are round through holes. The assembly holes 113 are used for connecting another component (not shown) to the connector 100. A plurality of positioning holes 114 are defined in the central plate 11. The positioning holes 114 are elliptic through holes. The positioning holes 114 are used for pre-positioning another component (not shown) relative to the connector 100.

An engaging hole 121 is defined in one end of the first extension plate 12. The engaging hole 121 is a round through hole. The engaging hole 121 is larger than the assembly holes 113 and the positioning holes 114. The engaging hole 121 is used for connecting another component (not shown) to the connector 100. An opposite end of the first extension plate 12 has a sloped edge. A height of the first extension plate 12 at the sloped edge decreases gradually from an inner end of the sloped edge to an outer end of the sloped edge. The second extension plate 13 has a rectangular shape. The second extension plate 13 extends from an opposite lateral side of the central plate 11 to the first extension plate 12, and extends from the central plate 11 in a direction opposite to the direction in which the first extension plate 12 extends from the central plate 11. The purpose is to assist the assembly of other elements to the connector 100.

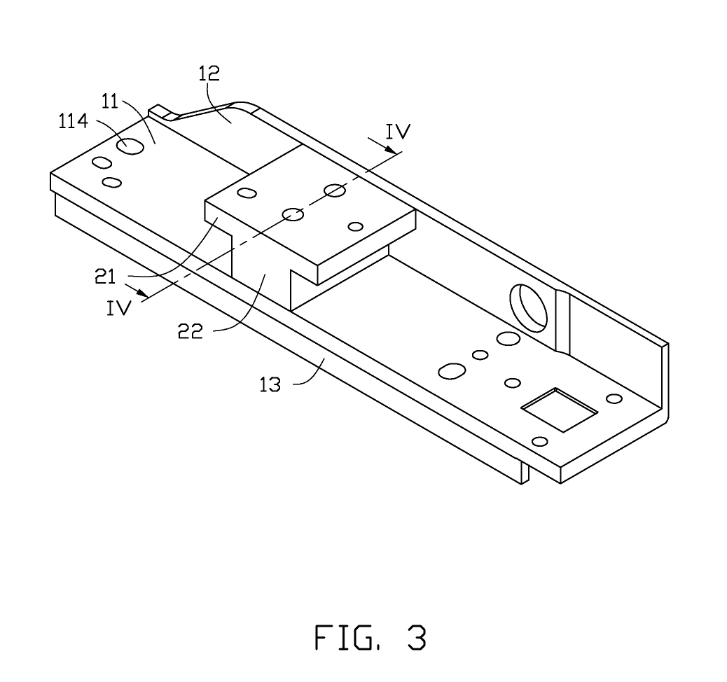

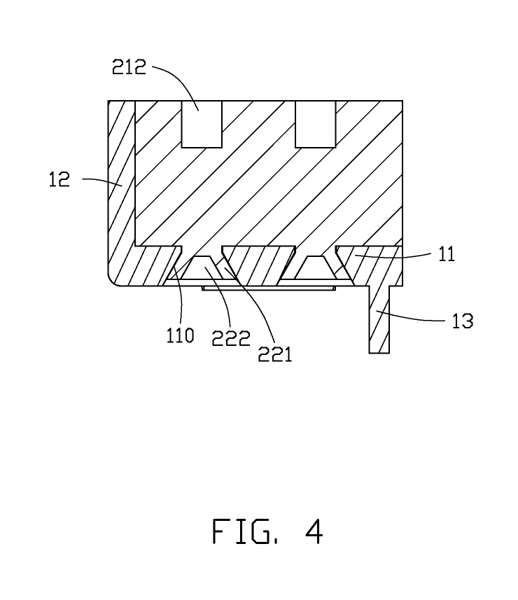

The block 20 has a T-shaped cross section. The block 20 comprises a first securing plate 21, and a second securing plate 22 extending upwardly from the first securing plate 21. The first securing plate 21 has a larger dimension compared with the second securing plate 22. Also referring to FIG. 3, the second securing plate 22 is positioned at a central portion of the first securing plate 21, and is attached to the central plate 11. Two securing holes 211 are defined in the first securing plate 21, at opposite sides of the second securing plate 22, respectively. As shown in FIGS. 3 and 4, two blind holes 212 are defined in the central portion of the first securing plate 21. The blind holes 212 and the second securing plate 22 are respectively located at bottom and top sides of the first securing plate 21. Two pins 221 extend upwardly from a top surface of the second securing plate 22. The pins 221 have a columnar configuration. The dimensions (diameters) of the pins 221 are substantially identical to the dimensions (diameters) of the riveting holes 110 at the bottom surface of the central plate 11. The positions of the pins 221 correspond to the positions of the blind holes 212, respectively. The pins 221 also correspond to the riveting holes 110 of the central plate 11, and are for inserting into the riveting holes 110, respectively. The blind holes 212 and the pins 221 can be formed by punching the block 20.

Referring to FIG. 4 again, in assembly of the main body 10 and the block 20, the pins 221 are inserted into the riveting holes 110 from the bottom surface of the central plate 11 until the top surface of the second securing plate 22 is attached to the bottom surface of the central plate 11. The pins 221 are then punched or riveted, so that the pins 221 are expanded to be fittingly and engagingly received in the riveting holes 110. In a typical embodiment, the expanded pins 221 are interferingly engaged in the riveting holes 110. Thereby, the pins 221 are totally received in the riveting holes 110, and no parts of the pins 221 are exposed beyond the top surface of the central plate 11. Thus, interference between the pins 221 and other elements that connect with the connector 100 is avoided. After the pins 221 are punched, a recess 222 is defined in each of the pins 221. In addition, the recess 222 (or a preform of the recess 222) can be predefined in each pin 221, for facilitating the punching/riveting process.

In summary, the connector 100 comprising the separate main body 10 and block 20 is easy to process compared with a similar connector that is constructed as a single piece. The main body 10 and the block 20 are engaged with each other by the punching or riveting process to meet the precision requirements of the positions of the relevant holes such as the securing holes 211, the assembly holes 113 and the positioning holes 114. The punching or riveting together of the main body 10 and the block 20 is also simpler than a conventional screwed engagement.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A connector comprising:
an elongate main body defining a plurality of riveting holes, dimensions of the riveting holes increasing gradually from a bottom surface of the main body to a top surface of the main body; and
a block comprising a plurality of pins extending to the main body, the pins received in the riveting holes and punched such that the pins are fittingly received in the riveting holes and engaged with the main body.

2. The connector of claim 1, wherein the main body comprises a central plate, and first and second extension plates extending from opposite lateral sides of the central plate respectively, the riveting holes being defined through the central plate.

3. The connector of claim 2, wherein the first extension plate extends downwardly from a bottom surface of the central plate, the second extension plate extends upwardly from a top surface of the central plate, and the dimensions of the riveting holes increase gradually along a direction from the bottom surface to the top surface of the central plate.

4. The connector of claim 2, wherein a reinforcing structure is formed at an end of the central plate, the reinforcing structure comprising a rectangular protrusion and three auxiliary holes near three sides of the protrusion.

5. The connector of claim 2, wherein a plurality of positioning holes is defined in the central plate, the positioning holes being elliptic.

6. The connector of claim 2, wherein an engaging hole is defined in one end of the first extension plate, the engaging hole being round.

7. The connector of claim 2, wherein the block comprising a first securing plate, and a second securing plate extending from the first securing plate and attached to the central plate of the main body.

8. The connector of claim 7, wherein the first securing plate is larger than the second securing plate, and the second securing plate is positioned at a central portion of the first securing plate.

9. The connector of claim 8, wherein a plurality of securing holes is defined in the first securing plate and positioned beside the second securing plate.

10. The connector of claim 7, wherein a plurality of recesses is defined in the first securing plate, and the pins extend from the second securing plate corresponding to the recesses respectively.

11. A connector comprising:
a main body comprising a central plate, a first extension plate extending downwardly from a lateral side of the central plate, and a second extension plate extending upwardly from an opposite lateral side of the central plate, a plurality of riveting holes being defined through the central plate; and
a block comprising a first securing plate and a second securing plate extending from the first securing plate and attached to the central plate of the main body, a plurality of pins extending from the second securing plate and received in the rivet holes of the central plate, the pins being punched and thereby engaged with the central plate.

12. The connector of claim 11, wherein dimensions of the riveting holes increase along a direction from the first extension plate to the second extension plate.

13. The connector of claim 12, wherein the pins are totally received in the riveting holes respectively.

14. The connector of claim 11, wherein a plurality of positioning holes and assembly holes are defined in the central plate, and a plurality of securing holes is defined in the first securing plate, the positioning holes, the assembly holes and the securing holes being located at different positions.
